(19) United States
(12) Patent Application Publication
(10) Pub. No.: US 2022/0124294 A1
(43) Pub. Date: Apr. 21, 2022

(54) SYSTEM AND METHOD FOR INTERACTIVELY RENDERING AND DISPLAYING 3D OBJECTS

(71) Applicant: XLIMINAL, INC., Irvington, NY (US)

(72) Inventor: Sunil VERMA, Irvington, NY (US)

(21) Appl. No.: 17/430,791

(22) PCT Filed: Feb. 6, 2020
(86) PCT No.: PCT/US2020/016954

§ 371 Date: Aug. 13, 2021

Related U.S. Application Data
(60) Provisional application No. 62/806,304, filed on Feb. 15, 2019.

(51) Int. Cl. H04N 13/111; G06T 19/00; H04N 13/239; G06V 20/20; H04N 13/156; H04N 13/15

(52) U.S. Cl. CPC H04N 13/111; G06T 19/006; H04N 13/239; H04N 2013/0077; H04N 13/156; H04N 13/15; G06V 20/20

(57) ABSTRACT

A 3D rendering solution that can include machine learning to convert static images into interactable 3D objects. The solution can analyze pixel data containing position data, color data and luminosity data. The solution can identify subobjects, which can include a collection of pixels at a specific location, with an infinite number of color luminosity combinations tied to perspective. The solution can use perspective as an input, along with a product feed and library of subobjects to render the interactable 3D objects. The solution can capture relative perspective with a protractic device to accurately measure relative perspective. The libraries can include libraries of subobjects along with their metadata. The solution can analyze pixel patterns to identify appropriate sets of subobjects to create new objects of the same object class, which can be further refined by the solution's ability to capture relative perspective.

### FIELD OF THE DISCLOSURE

The present disclosure relates to a system, method and computer program for converting static images into interactable three-dimensional (3D) objects; and, more particularly, the disclosure relates to a system, method and computer program for rendering interactable 3D objects from static images for interactive commerce, augmented or mixed reality environments.

### BACKGROUND OF THE DISCLOSURE

Computer-generated solutions are being used daily in applications such as, for example, animation, gaming, advertising, and virtual reality (VR). The solutions typically include simulation of interactive 3D objects, including generation of 3D objects or conversion of two-dimensional (2D) images into 3D objects. The demand for these solutions is growing at an ever-increasing pace.

Currently, three basic solutions are commonly employed to generate 3D renderings. The first one involves brute force, which consists of designers manually drawing objects in 3D. The second employs photogrammetry, which stitches together static images to generate 3D objects. The third involves 3D rendering machines, such as 3D scanners, which are prohibitively expensive and inherently flawed, since camera lenses are used in such machines that are unable to capture enough information to replicate the experience of the human eye and replicate the functionality of the human eye and brain.

The first solution is prohibitively expensive to implement, as well as prohibitively resource-intense, requiring lengthy and unwieldy project timelines.

The second and third solutions are similar and generally work via a point cloud. They also have a lot of the same limitations. Point clouds in both solutions are typically too dense to be practical, since corresponding 3D objects are too big to handle. These solutions necessitate manual painting, requiring teams of engineers working on automating processes to reduce the density of polygons generated by point clouds. Neither of these solutions is able to capture textures and reflections appropriately. For instance, 3D scanners are particularly weak at capturing textures because these machines tend to work by capturing light reflected off the object being rendered.

While the above solutions can provide impressive results, the solutions can be time-consuming, prohibitively expensive, and the results do not satisfy sophisticated users that desire higher quality 3D renderings. There exists an unfulfilled need for a technological solution that can convert static images into quality, interactive 3D objects that can satisfy even the most discerning requirements of sophisticated users, while doing so cost-efficiently.

### SUMMARY OF THE DISCLOSURE

The disclosure provides a technological solution for converting static images into interactable 3D renderings that can satisfy the quality and cost requirements of the most discerning users. The solution includes a system, method, and computer program for converting static images into 3D renderings, and for displaying the 3D renderings in an augmented or mixed reality application on a communicating device. The application can include, for example, an ecommerce application, a medical application, a scientific application, an educational application, or any other application that can benefit from the technological solution. The technological solution can include an input process, a 3D rendering process, and an environment augmenting process, as described herein.

A nonlimiting embodiment of the solution includes a method for rendering an object in three-dimensions that can be displayed as an interactable 3D object in an augmented reality environment. The method can comprise: receiving static image data; receiving declination data associated with the static image data; analyzing the static image data and declination data to identify a subobject; querying a catalog based on the identified subobject data and retrieving a rendered subobject; rendering a 3D image of the object using the retrieved rendered subobject; and transmitting the rendered 3D object to be rendered on a display device. The method can further comprise receiving object feed data and analyzing the object feed data with the static image and declination data to identify the subobject. The declination data can be determined using a protractic device. The method can include a quality assurance process that comprises converting the 3D image of the object to a two-dimensional (2D) static image and comparing the resultant 2D still image against the received, original static image data. The process of converting the 3D image to a 2D static image can further comprise generating associated declination data associated with each 2D static image.

The solution can include a method for rendering an object in three-dimensions and displaying the object in an augmented reality environment, where the method comprises: receiving static image data; receiving object rendering data corresponding to the static image data; analyzing the static image data to identify a subobject; querying a catalog based on the identified subobject and retrieving a rendered subobject; rendering an interactable 3D image of the object using the retrieved rendered subobject; and transmitting the interactable 3D object to a display device, wherein the object rendering data comprises at least one of declination data and color distortion data. The method can comprise receiving object feed data and analyzing the object feed data with the static image and object rendering data to identify the subobject.

In the method, the object rendering data can be determined using a protractic device or a protratic device and an image pickup device.

The method can comprise converting the interactable 3D image of the object to a two-dimensional (2D) static image and comparing the 2D still image against the received static image data.

In the method, converting the interactable 3D image to the 2D static image can comprise generating associated object rendering data.

In the method, the associated object rendering data can comprise at least one of associated declination data, associated color distortion data or associated luminosity data.

Another nonlimiting embodiment of the solution comprises a non-transitory computer readable storage medium storing executable computer program instructions that, when executed on a computing device, cause the computing device to perform a method comprising: receiving static image data; receiving object rendering data corresponding to the static image data; analyzing the static image data to identify a subobject; querying a catalog based on the identified subobject and retrieving a rendered subobject; rendering an interactable 3D image of the object using the retrieved rendered subobject; and transmitting the interactable 3D object to a display device, wherein the object rendering data comprises at least one of declination data and color distortion data.

In the non-transitory computer readable storage medium, the method can comprise receiving object feed data and analyzing the object feed data with the static image and object rendering data to identify the subobject. The object rendering data can be determined using a protractic device. The object rendering data can be determined using a protractic device and an image pickup device.

In the non-transitory computer readable storage medium, the method can comprise converting the interactable 3D image of the object to a two-dimensional (2D) static image and comparing the 2D still image against the received static image data. Converting the interactable 3D image to the 2D static image can comprise generating associated object rendering data. The associated object rendering data can comprise at least one of associated declination data, associated color distortion data or associated luminosity data.

A further nonlimiting embodiment of the solution comprises a system for rendering an object in three-dimensions and displaying the object in an augmented reality environment. The system comprises a three-dimensional renderer arranged to: analyze image content and object rendering data corresponding to an image of an object in the image content; identify a subobject based on the image content; retrieve a rendered subobject based on the identified subobject; merge the rendered subobject with another subobject to render an interactable 3D image of the object; and, transmit the interactable 3D image of the object to a communicating device, wherein the object rendering data comprises at least one of declination data and color distortion data. The system can comprise a protractic device arranged to attach to a surface of the object and an image pickup device having a field of view and arranged to capture an image of the protractic device in the field of view to determine an object declination or color distortion, wherein the declination data and color distortion data comprise the object declination and color distortion, respectively.

In the system, the protractic device can comprise a first panel and a second panel. The first and second panels can be arranged to be parallel and juxtapositioned with respect to each other. The first and second panels can comprise first and second planar panels, respectively. The protractic device can comprise a pair of lenticular lenses.

A further nonlimiting embodiment of the solution can include a three-dimensional renderer apparatus that can render a 3D image of an object to be displayed on a display device in an augmented or mixed reality application. The apparatus can comprise: a deep neural network that receives and analyzes static images, declination data and product feed data to identify a subobject; a database that stores one or more libraries containing rendered subobjects; a 3D cataloger that queries the database and selects a rendered subobject based on the identified object, or an identified portion of the object, such as, for example, a polygon or a group of polygons; a 3D model builder that renders a 3D image of the object using the selected rendered subobject; and a transceiver that transmits the rendered 3D object to the display device.

The technological solution can include a protractic device for use in determining declination data or color distortion data for an object to be rendered in 3D. The protractic device can comprise a first planar panel and a second planar panel. The first and second panels can be parallel and juxtapositioned to each other. The protractic device can comprise a pair of lenticular lenses.

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows an example of an augmented reality (AR) environment, constructed according to the principles of the disclosure.

FIGS. 2A and 2B show respective front and back views of an example of a communicating device that can be included in the AR environment in FIG. 1.

FIG. 3 shows a block diagram of an example of a 3D renderer that can be included in the AR environment in FIG. 1.

FIG. 4 shows a flow diagram of static images being received from various sources by the 3D renderer in FIG. 3.

FIG. 5 shows an example of a protractic device that is constructed according to the principles of the disclosure;

FIG. 6 shows an exploded view of the protractic device in FIG. 5.

FIG. 7 depicts the multiple rotational axes of visibility via the protractic device in FIG. 5.

FIG. 8 shows various examples of relations between a front panel and a back panel of the protractic device in FIG. 5.

FIG. 9 shows an example of a relation of the front and back panels in the protractic device in FIG. 5 at different viewing angles.

FIG. 10 shows an example of a view of an object with multiple protractic devices affixed to the object.

FIG. 11 shows another view of the object having multiple protractic devices affixed to it.

FIG. 12 shows an example of a 3D rendering process, according to the principles of the disclosure.

FIGS. 13A to 13C show examples of three phases that can be carried out by the 3D renderer in FIG. 3.

FIG. 14 depicts a flow diagram that illustrates an example of a quality assurance process that can be carried out by the 3D renderer in FIG. 3.

FIGS. 15A and 15B depict a flow diagram of a 3D rendering process carried out by the 3D renderer in FIG. 3.

The present disclosure is further described in the detailed description that follows.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that features illustrated in the drawings are not necessarily drawn to scale, and features of one embodiment may be employed with other embodiments as those skilled in the art would recognize, even if not explicitly stated. Descriptions of well-known components and processing techniques may be omitted so as to not unnecessarily obscure the embodiments of the disclosure. The examples are intended merely to facilitate an understanding of ways in which the disclosure may be practiced and to further enable those skilled in the art to practice the embodiments of the disclosure. Accordingly, the examples and embodiments should not be construed as limiting the scope of the disclosure. Moreover, it is noted that like reference numerals represent similar parts throughout the several views of the drawings.

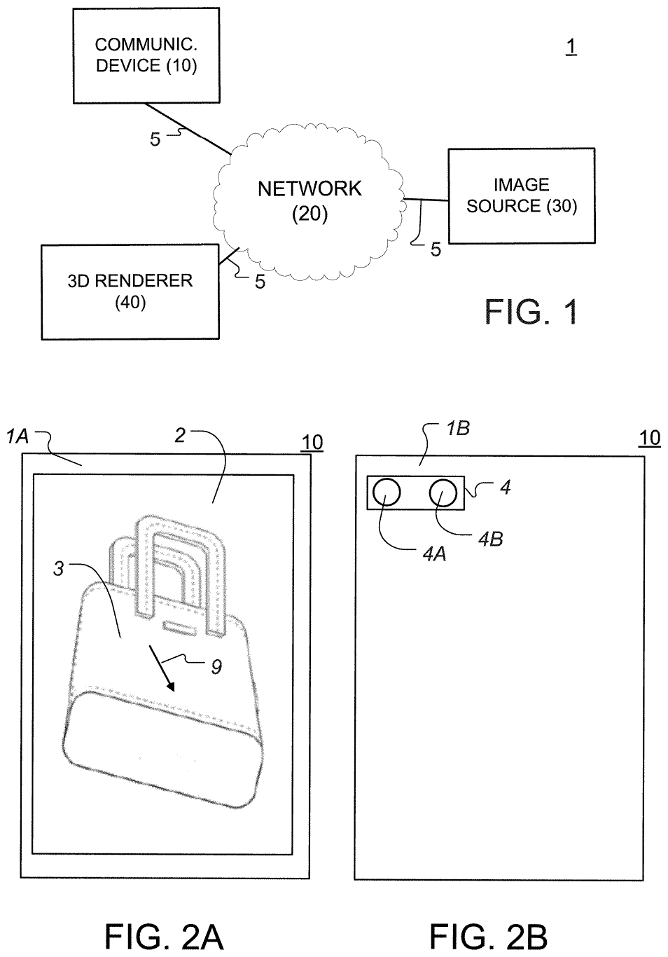

FIG. 1 shows an example of an augmented (or mixed) reality (AR) environment 1, according to the principles of the disclosure. The AR environment 1 can include a communicating device 10, a network 20, and a 3D renderer 40. The AR environment 1 can include an image source 30. While the AR environment 1 is shown with a single communicating device 10 and a single image source 30, it is noted that the AR environment 1 can include any number of communicating devices 10 or image sources 30, without limitation. The renderer 40 can be configured to carry out any one or more of an input process, a rendering process, or a quality assurance process, as disclosed hereinbelow.

The renderer 40 and communicating device 10 can be integrated or integrateable in a single computing device or module (not shown), or provided as separate computing devices or modules, as seen in FIG. 1.

FIGS. 2A and 2B show a front view 1A and a back view 1B, respectively, of an example of a communicating device 10. In this non-limiting embodiment, the communicating device 10 can include, for example, a smartphone, a computer tablet or any communicating device that has a display device. The communicating device 10 can include a display device 2, which can be used to display an object 3. The communicating device 10 can include an image pickup unit 4, which can include one or more lenses (for example, lenses 4A, 4B, shown FIG. 2B). The image pickup unit 4 can include one or more image pickup devices (not shown). The image pickup unit 4 can include a stereo digital camera. The image pickup device(s) (not shown) can include, for example, a charge-coupled device (CCD), or any other device suitable to capture an image of an area in the AR environment 1 and convert the captured image to a digital image signal that can be used to reproduce the image of the area in the AR environment 1 with the object 3 included on the display device 2 (shown in FIG. 2A). The size of the area in the captured image can depend on the field of view of the image pickup unit 4.

Referring to FIGS. 1, 2A, and 2B, the renderer 40 can be employed to convert static two-dimensional (2D) images into interactable 3D renderings, and to display the interactable 3D renderings on the communicating device 10 alone or as part of an augmented reality that includes the rendered interactable 3D object 3 embedded in the real-world image captured by the image pickup unit 4. The 3D rendered object 3 can be displayed in the real-time, real-world image that is captured by the image pickup unit 4 and displayed on the display device 2, such that the rendered image of the object 3 reacts to the environment within which it is placed. The 3D renderings can be displayed in an augmented or mixed reality application such as, for example, an ecommerce application, a medical application, a scientific application, an educational application, or any other application that can benefit from the technological solution.

For instance, in an ecommerce application, the rendered interactive 3D object 3 (shown in FIG. 2A) can include a merchandise article, such as, for example, the purse seen in FIG. 2A. The object 3 can be rendered on the communicating device 10 in the real-world image captured by the image pickup unit 4. The object 3 can be rendered such that the user can interact with the object 3 by, for example, touching or manipulating the displayed image of the object 3 on the display device 2. The object 3 can be interacted with by the user by, for example, positioning the user's hand in the field of view of the image pickup unit 4, manipulating the image pickup unit 4 or user's hand while capturing a real-time image of the user's hand (not shown) to position the user's hand in a desired position with respect to the object 3 rendered on the display device 2, and displaying the user's hand and object 3 as the hand manipulates or interacts with the object 3, providing a real-world augmented reality on the display device 2. Additionally, the environment of the real-world image captured by the image pickup unit 4 can be analyzed by the renderer 40 and the object 3 can be rendered as reacting to the environment. For example, the object 3 can be rendered as being placed in a sunlit environment and then rendered with appropriate contrast, lighting, or other environmental effects, so that it appears realistic in the particular environment when displayed on the display device 2.

The image source 30 (shown in FIG. 1) can include, for example, a server (not shown), a 3D scanner, a 3D camera, a digital camera, a computer, a 3D computer-aided-design (CAD) generator, a communicating device, or any other source of image data for a 3D interactable object 3 that can be rendered on the communicating device 10 (shown in FIGS. 1, 2A, 2B). The image source 30 can provide the image data as an image signal and transmit the image signal to the renderer 40. The image signal can include a digital image signal comprising a multidimensional array of pixel data, such as, for example, a 2D array (for example, 3872×2592 pixel resolution for 10 megapixel image) or a 3D array (for example, R, G, B channels each having 3872×2592 pixel resolution). The image signal can be transmitted from the image source 30 to the renderer 40 via one or more communication links, or the image signal can be fed directly to the renderer 40, such as, for example, via a memory stick, a compact disc read-only memory (CD-ROM), a digital versatile disc (DVD), a communication link, or any other mechanism capable of transmitting or providing image data to the renderer 40. The image signal can be transmitted to the renderer 40 over the network 20 (shown in FIG. 1). The image signal can include multidimensional (for example, 2D, 3D, 4D, or more dimensions) static image data or point cloud data. The image data can include object rendering data, including, for example, object declination data, object feed data, object color distortion data, or light field data. The object feed data can include metadata for the object and light field data can include volumetric data. The image source 30 can belong to, for example, a manufacturer, a vendor, a merchant, a supplier, an academic institution, a government entity, a service provider, or any other entity or individual. The image signal can include, for example, an object data feed, including metadata about an object in the image signal. In ecommerce applications, the object data feed can include a product data feed. The object data feed can include one or more files, which can include a list of objects or attributes of those objects organized so that each object can be displayed on the display device 2 of the communicating device 10 (shown in FIGS. 1, 2A, 2B). The object data feed can include one or more images of each object (or portion of an object), a title, an identifier for each object, one or more attributes for each object, or any other data relating to the object. The one or more images can include a plurality of static images showing the object from various vantages, including, for example, a top view, a front view, a back view, a bottom view, a left-side view, a right-side view, a perspective view, or any combination of the foregoing.

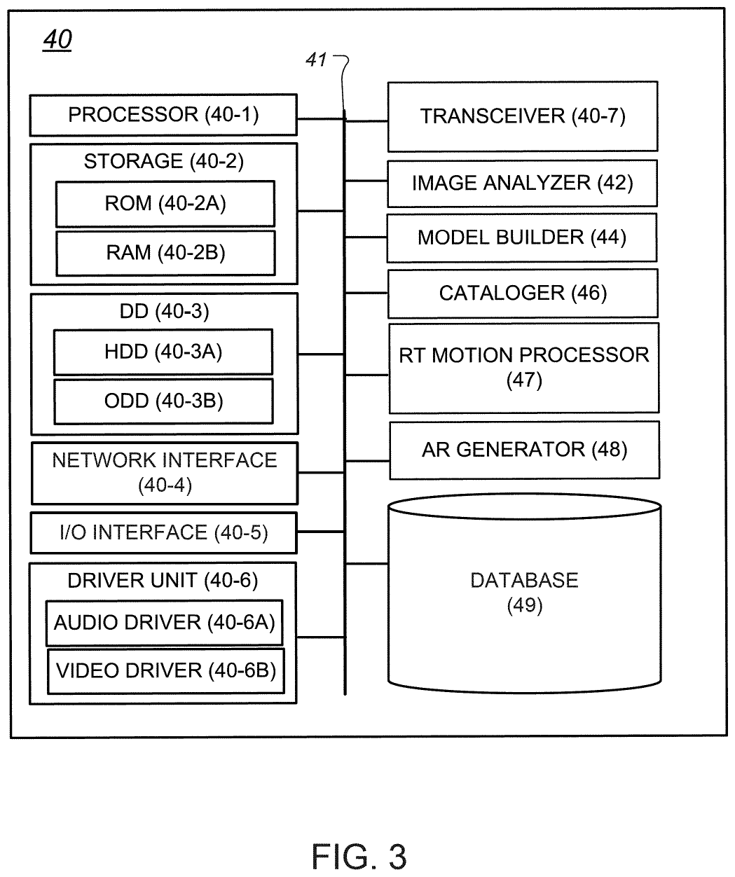

FIG. 3 shows a block diagram of a nonlimiting example of the renderer 40, constructed according to the principles of the disclosure. The renderer 40 can include a processor 40-1, a storage 40-2, a disk drive (DD) 40-3, a network interface 40-4, an input/output (I/O) interface 40-5, a driver unit 40-6, a transceiver 40-7, an image analyzer 42, a model builder 44, and a multidimensional (for example, 3D) cataloger 46. The renderer 40 can include a real-time (RT) motion processor 47. The renderer 40 can include an augmented reality (AR) generator 48. The renderer 40 can include a database 49. The transceiver 40-7 can include a transmitter or receiver. The renderer 40 can include a bus 41. The bus 41 can be connected to each of the components in the renderer 40 via a communication link. The components 40-1 to 40-7, 42, 44 and 46-48 can include separate or distinct modules or computing devices or a single module or computing device. Any one or more of the components 40-2 to 40-7, 42, 44, 46-48 can include a computing device or a module that is separate from the processor 40-1, as seen in FIG. 3, or integrated or integrateable in a computing device such as the processor 40-1.

The renderer 40 can include a sound generation device (not shown), such as, for example, a speaker, a sound pickup device (not shown), such as, for example, a microphone, or a display device (not shown), such as, for example, a light emitting diode (LED) display or a liquid crystal display (LCD). The renderer 40 can include a voice command device (not shown), a smart voice recognition (not shown) or a voice activated device (not shown).

Any one or more of the components 42 through 48 can be implemented as one or more computing devices or machine learning platforms. The machine learning platform can include, for example, an artificial neural network (ANN), a convolutional neural network (CNN), a deep CNN (DCNN), an RCNN, a Mask-RCNN, a deep convolutional encoder-decoder (DCED), a recurrent neural network (RNN), a neural Turing machine (NTM), a differential neural computer (DNC), a support vector machine (SVM), a deep learning neural network (DLNN), Naive Bayes, decision trees, linear regression, Q-learning, temporal difference (TD), deep adversarial networks, fuzzy logic, or any other machine intelligence platform capable of supervised learning.

The processor 40-1 can include any of various commercially available computing devices, including for example, a central processing unit (CPU), a graphic processing unit (GPU), a general-purpose GPU (GPGPU), a field programmable gate array (FGPA), an application-specific integrated circuit (ASIC), a manycore processor, multiple microprocessors, or any other computing device architecture can be included in the processor 40-1.

The renderer 40 can include a non-transitory computer-readable storage medium that can hold executable or interpretable computer program code or instructions that, when executed by the processor 40-1, or one or more of the other components (for example, computing devices or modules) in the renderer 40, can cause the steps, processes or methods in this disclosure to be carried out. The computer-readable storage medium can be included in the storage 40-2 or DD 40-3. The computer readable storage medium can include sections or segments of computer program code or instructions that, when executed by one or more components in the renderer 40, can cause the renderer 40 to carry out the processes set forth in or contemplated by this disclosure.

The storage 40-2 can include a read only memory (ROM) 40-2A and a random-access memory (RAM) 40-2B. A basic input/output system (BIOS) can be stored in the non-volatile memory 40-2A, which can include, for example, a ROM, an erasable programmable ROM (EPROM), or an electrically erasable programmable ROM (EEPROM). The BIOS can contain the basic routines that help to transfer information between components in the renderer 40, such as during start-up. The RAM 40-2B can include a high-speed RAM such as static RAM for caching data.

The DD 40-3 can include a hard disk drive (HDD) 40-3A and an optical disk drive (ODD) 40-3B. The HDD 40-3A can include an enhanced integrated drive electronics (EIDE) drive or a serial advanced technology attachments (SATA) drive. The ODD 40-3B can include a read/write from/to a CD-ROM disk (not shown), or, read from or write to other high capacity optical media such as a digital versatile disc (DVD). The HDD 40-3A or ODD 40-3B can be arranged for external use in a suitable chassis (not shown). The DD 40-3 can be connected to the bus 41 by a hard disk drive interface (not shown) and an optical drive interface (not shown), respectively. The hard disk drive interface (not shown) can include, for example, a Universal Serial Bus (USB) (not shown) or an IEEE 1394 interface (not shown) for external applications.

The storage 40-2 or DD 40-3, including computer-readable media, can provide nonvolatile storage of data, data structures, or computer-executable instructions. The storage 40-2 or DD 40-3 can accommodate the storage of any data in a suitable digital format. The storage 40-2 or DD 40-3 can include one or more computing resources such as, for example, program modules or software applications that can be used to execute aspects of the architecture included in this disclosure.

One or more computing resources can be stored in the storage 40-2 or DD 40-3, including, for example, an operating system (OS), an application program, an application program interface (API), a program module, or program data. The computing resource can include an API such as, for example, a web API, a simple object access protocol (SOAP) API, a remote procedure call (RPC) API, a representation state transfer (REST) API, or any other utility or service API. One or more of the computing resources can be cached in the RAM 40-2B as executable sections of computer program code or retrievable data.

The network interface 40-4 can be connected to a network such as the network 20 (shown in FIG. 1) or the Internet (not shown). The network interface 40-4 can be connected to one or more communicating devices in the network 20 (shown in FIG. 1). The network interface 40-4 can include a wired or a wireless communication network interface (not shown) or a modem (not shown). When used in a LAN, the renderer 40 can be connected to the LAN through the wired or wireless communication network interface; and, when used in a wide area network (WAN), the renderer 40 can be connected to the WAN network through the modem. The modem (not shown) can be internal or external and wired or wireless. The modem can be connected to the bus 41 via, for example, a serial port interface (not shown). The modem can be included in the transceiver 40-7.

The (I/O) interface 40-5 can receive commands or data from, for example, an operator. The I/O interface 40-5 can be arranged to connect to or communicate with one or more input/output devices (not shown), including, for example, a keyboard (not shown), a mouse (not shown), a pointer (not shown), a microphone (not shown), a speaker (not shown), or a display (not shown). The received commands and data can be forwarded from the I/O interface 40-5 as instruction or data signals via the bus 41 to any component in the renderer 40.

The driver unit 40-6 can include an audio driver 40-6A and a video driver 40-6B. The audio driver 40-6A can include a sound card, a sound driver (not shown), an interactive voice response (IVR) unit, or any other device necessary to render a sound signal on a sound production device (not shown), such as for example, a speaker (not shown). The video driver 40-6B can include a video card (not shown), a graphics driver (not shown), a video adaptor (not shown), or any other device necessary to render an image signal on a display device (not shown).

The transceiver 40-7 can include a transmitter or receiver that can transmit or receive signals having frequencies in the electromagnetic spectrum, including, for example, radio frequency (RF), infrared (IR), or visible spectrum (for example, optical signal) signals.

The image analyzer 42 can include a neural network (NN) or a deep neural network (DNN), such as, for example, a deep convolutional neural network (DCNN), or any other machine intelligence that can perform similarly, or better than a CNN or DCNN, including other types of deep neural networks. The image analyzer 42 can include a machine learning platform such as, for example, an ANN, CNN, DCNN, RCNN, Mask-RCNN, DCED, RNN, NTM, DNC, SVM, DLNN, TD, Naive Bayes, decision trees, linear regression, Q-learning, deep adversarial networks, fuzzy logic, or any other machine intelligence platform capable of supervised or unsupervised learning. The image analyzer 42 can be arranged to receive image data from the image source 30 (shown in FIG. 1). The image analyzer 42 can be arranged to receive object rendering data, object feed data, material property data, or any other data relating to the object 3 to be rendered on the communicating device 10 as interactable (shown in FIG. 1). The image analyzer 42 can be arranged to process the image data and detect, classify and track content in the image data. The image analyzer 42 can analyze every pixel in the received image data and make a prediction at every pixel.

The image analyzer 42 can be arranged to receive image data and format the image data into multidimensional pixel matrix data, which can include, for example, N×R×C, where N is the number of spectral channels (for example, Red, Green, Blue color channels), R is the number of rows of pixels and C is the number of columns of pixels. After formatting the image data into multidimensional pixel matrix data, the image analyzer 42 can filter each pixel matrix using a filter matrix, such as, for example, in a CNN. The image analyzer 42 can slide and apply one or more filter matrices across all pixels in each pixel matrix to compute dot products and detect patterns, creating convolved feature matrices having the same size as the filter matrix. The image analyzer 42 can slide and apply multiple filter matrices to each pixel matrix to extract a plurality of feature maps.

After the feature maps are extracted, they can be moved to one or more layers in a deep neural network (for example, in the CNN) to locate the features, and the rectified feature maps can be moved to one or more pooling layers to down-sample and reduce the dimensionality of each feature map. The down-sampled data can be output as multidimensional data arrays. The resultant multidimensional data arrays output from the pooling layers can be converted into single continuous linear vectors that can be forwarded to a fully connected layer and flattened matrices from the pooling layer can be fed as inputs to a fully connected neural network layer, which can auto-encode the feature data and classify the image data. The fully connected layer can include a plurality of hidden layers and an output layer, as will be understood by those skilled in the art. The resultant image cells can predict the number of bounding boxes that might include an object, as well as confidence scores that indicate the likelihood that the bounding boxes might include the object. The image analyzer 42 can include bounding box classification, refinement and scoring based on the object in the image represented by the image data. The image analyzer 42 can determine position data, such as, for example, x-y-z Cartesian coordinate data, for the object and the bounding box, dimension data (for example, height, width, depth) of the object and the bounding box, orientation data (for example, angular position or attitude) of the object and bounding box, and probability data that indicates the likelihood that a given bounding box contains the object.

The image analyzer 42 can analyze content in the image data, recognize patterns and carry out image recognition, object classification, and 3D rendering of content in the image data, including any objects the image data. As noted above, the image data can include point cloud data that can be processed by the image analyzer 42 to detect, classify and track an object in the image data. The image analyzer 42 can be trained using training data, such as, for example, synthetic data obtained from the renderer 40 by, for example, generating static 2D images from rendered 3D objects and comparing the generated static images against the original static images that were input into the image analyzer 42 and used to generate the 3D objects. The image analyzer 42 can be trained using training data, such as, for example, augmented or mixed reality datasets, or manually annotated real image data.

At its core, the image data received by the image analyzer 42 can include image pixel data of a collection of pixels that hold information relating to position (such as, for example, x-y-z Cartesian coordinate system), color (such as, for example, red, green, blue) and luminosity or brightness. The pixel data can be processed as polygon data. A polygon can be a foundational element for a 3D object that can include a collection of pixels at a specific location, with an infinite number of color luminosity combinations tied to perspective.

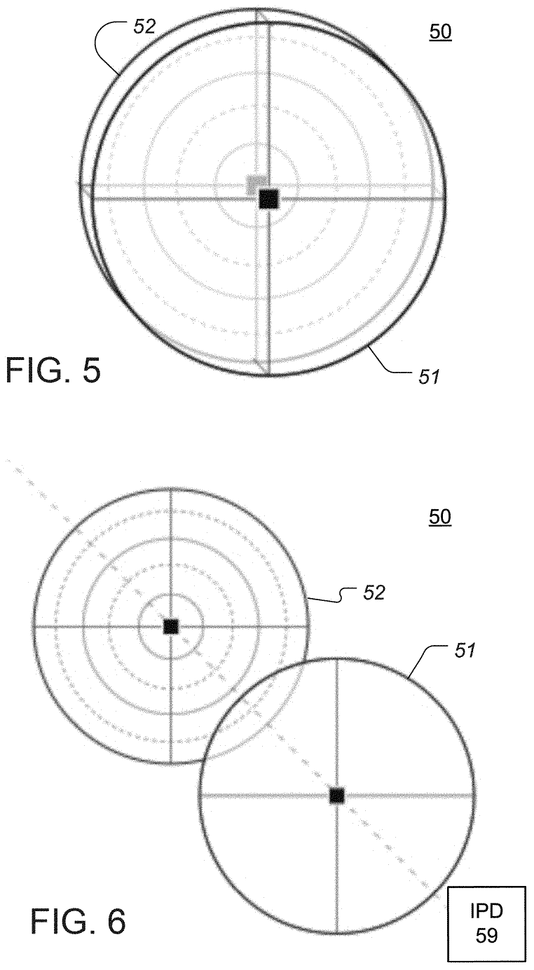

The image analyzer 42 can receive, as inputs, perspective data, object feed data (such as, for example, product feed data such as merchandise specifications or descriptions) and catalog data. The perspective data can include measurement data determined by measuring a relative perspective using a protractic device, such as, for example, the protractic device 50 (shown in FIG. 5) described below in greater detail. The catalog data can include data relating to subobjects along with their metadata. The catalog data can be received from, for example, the cataloger 46. The catalog data can be used by the image analyzer 42 in object recognition or classification. The subobjects can be identified based on pixel patterns in the image data analyzed by the image analyzer 42. The subobjects can be used to create new objects of the same or similar object type (such as, for example, merchandise class) further refined by an ability to capture relative perspective. The subobjects can include polygons or 3D models that can be queried for matchability with relatable portions of objects that can be rendered into 3D from input static images.

The image analyzer 42 can extract image information from the received image data, which, as noted above, can include, for example, 2D static image data or point cloud data. The image analyzer 42 can include a hierarchically methodology to extract image information or content from the image data. The image analyzer 42 can extract oriented edge data, pattern data, texture data, or any other data relating to an object in the image data. As noted above, the image analyzer 42 can receive object rendering data, including, for example, position data (such as, for example, x-y-z Cartesian coordinate data), color data (such as, for example, red, green, blue) and luminosity data. The position data can include relative perspective data, which can include a relative angle between the object and an image pickup device, which can be measured by the protractic device 50 (shown in FIG. 5). The image analyzer 42 can analyze the image data, and the analysis results can be used by the cataloger 46 to identify and retrieve matching subobjects, such as, for example, polygons, groups of polygons, or 3D models.

The model builder 44 can receive, as inputs, the analysis results data from the image analyzer 42 and the subobjects from the cataloger 46 and render an interactable 3D image of the object that was the subject in the image data (for example, static images) that was input to the image analyzer 42. The model builder 44 can receive, as an input, real-time motion and environmental data from the RT motion processor 47 to render a real-world 3D image of the object, factoring in context-sensitive data, such as, for example, how each portion (for example, polygon or group of polygons) of the 3D object to be rendered will interact with the environment in the real-world image captured by, for example, the image pickup unit 4 (shown in FIG. 2B) and move as a function of time and position in the augmented reality environment, including the effect of environmental variables, such as, for example, perspective, motion, wind direction, wind speed, temperature, pressure, moisture content, rain, snow, hail or other environment-related information on portions of the 3D object—for example, rendering the 3D object 3 on the display device 2 (shown in FIG. 2A) as interacting with the augmented reality environment, with rain droplets on its surface that move in a direction and at a velocity determined based on the augmented reality environment, which in this example can include rain interacting with the object 3. In this regard, the model builder 44 can use context-sensitive polygons to render the 3D image such that it appears realistically in contextual aspects in the augmented reality environment.

The model builder 44 can be arranged to resize and merge subobjects to render a merged model for the interactable 3D object 3. The model builder 44 can be arranged to provide computer graphic processing such as, for example Edge loops, UV mapping, and procedural texturing, as will be understood by those skilled in 3D image processing.

The cataloger 46 can include one or more libraries of subobjects, including associated metadata. The libraries can include one or more libraries dedicated to each category or type of object that can be included in the image data. The cataloger 46 can be integrated with the image analyzer 42 as a single computing device or module, or as a separate computing device or module, as seen in FIG. 3. The cataloger 46 can catalog all elements of an object being rendered to enable re-use of subobjects to later render new 3D objects. The process of cataloging can include identifying and classifying (or categorizing) one or more portions of an object. Each portion can be equivalent to, for example, a polygon or a group of polygons. The cataloger 46 can be arranged to build libraries of subobjects, or it can be arranged to retrieve or store libraries of subobjects, such as, for example, in the database 49. The cataloger 46 can be arranged to retrieve subobjects based on the image data from the image source 30 (shown in FIG. 1) or based on the analysis results data from the image analyzer 42. The cataloger 46 can be arranged to query the database 49 for matching 3D modeling data, such as, for example, polygon data.

The RT motion processor 47 can include machine intelligence, such as, for example, a deep neural network. The RT motion processor 47 can include a machine learning platform, such as, for example, ANN, CNN, DCNN, RCNN, a Mask-RCNN, DCED, RNN, NTM, DNC, SVM, DLNN, TD, Naive Bayes, decision trees, linear regression, Q-learning, deep adversarial network, fuzzy logic, or any other machine intelligence platform capable of supervised or unsupervised learning. The RT motion processor 47 can be integrated with the image analyzer 42, model builder 44, or cataloger 46, such as, for example, in a single module or computing device, or provided as a separate computing device or module, as seen in FIG. 3.

The RT motion processor 47 can be arranged to receive real-world image data from the communicating device 10 (shown in FIG. 1), such as, for example, a real-world moving image captured in real-time by the image pickup unit 4 (shown in FIG. 1). The RT motion processor 47 can be arranged to analyze image content in the real-world image data and detect, classify and track image content as a function of time, including environmental variables. The RT motion processor 47 can be arranged to output image content analysis results data such that the 3D object 3 (shown in FIGS. 2A, 2B) can be rendered as an object that can interact with an augmented reality displayed on the display device 2 of the communicating device 10, such that the object is rendered as a realistic object in the real-world moving image.

The RT motion processor 47 can analyze real-world image data from the image pickup unit 4 (shown in FIG. 2B) and determine environmental variable data for the image content captured by the image pickup unit 4. The RT motion processor 47 can generate predictive data that can be used by the model builder 44 to predict how subobjects, such as, for example, polygons, will morph as a function of time, position and environmental variables, such as, for example, the position, direction and intensity of the environmental variables. The 3D builder 44 can render the 3D object such that it reacts realistically to the environment within which it is placed.

The AR generator 48 can be integrated with the image analyzer 42, model builder 44, cataloger 46, or RT motion processor 47, such as, for example, in a single module or computing device, or provided as a separate computing device or module, as seen in FIG. 3. The AR generator 48 can be arranged to interact with components 42 to 47 and generate an augmented reality display signal that includes the image content captured by the image pickup unit 4 (shown in FIG. 2B) and the interactable 3D object 3 (shown in FIG. 2A) adapted to interact with the captured image content as a function of time. The augmented reality display signal can include a real-world interactable 3D image of the object 3 and captured image content that factors in context-sensitive data, such as, for example, how each portion (for example, polygon or group of polygons) of the rendered 3D object moves as a function of time and position in the augmented reality image content, including the effect of environmental variables, such as, for example, perspective, motion, wind direction, wind speed, temperature, pressure, moisture content, rain, snow, hail or other environment-related information on portions of the 3D object. The AR generator 48 can receive the rendered 3D object image data from the model builder 44, or it can interact with the model builder 44 to generate the 3D object image data. The AR generator 48 can receive the real-world image data from the communicating device 10 (shown in FIGS. 1, 2A, 2B) or image pickup unit 4 (shown in FIG. 2B).

In a nonlimiting application, the AR generator 48 can generate an augmented reality display signal that can be displayed on the communicating device 10 (shown in FIG. 2A) to include the captured image content with the interactable 3D object 3 (shown in FIG. 2A) responding to the captured image content, such as, for example, rain droplets falling on the surface of the object 3 and moving in a direction and at a velocity that is dependent on the image content, which in this example can include a rain droplet moving along a vector 9 (shown in FIG. 2A) that is parallel to the direction of gravity.

The database 49 can be arranged to store 3D modeling data, such as, for example, polygon data, one or more libraries of subobjects, including associated metadata, image pixel data, results data from the image analyzer 42, model builder 44, cataloger 46, RT motion processor 47, or AR generator 48. The database 49 can include libraries of subobjects that are dedicated to each category or type of object. The database 49 can store object rendering data or product feed data. The database 49 can include training datasets that can be employed to train components in the renderer 40 that include machine intelligence, such as, for example, the image analyzer 42, model builder 44, cataloger 46, RT motion processor 47 or AR generator 48. The database 49 can include a Big Database, such as, for example, an Apache Hadoop database. The database 49 can be arranged to be accessed by any one or more of the components in the renderer 40. The database 49 can be arranged to receive queries and, in response, retrieve specific records, files or data or portions of records, files or data based on the queries. The database 49 can include a database management system (DBMS) that can interact with the components in the renderer 40. The database 49 can include a DBMS such as, for example, SQL, MySQL, Oracle, Access, or Unix. The database 49 can include a relational database.

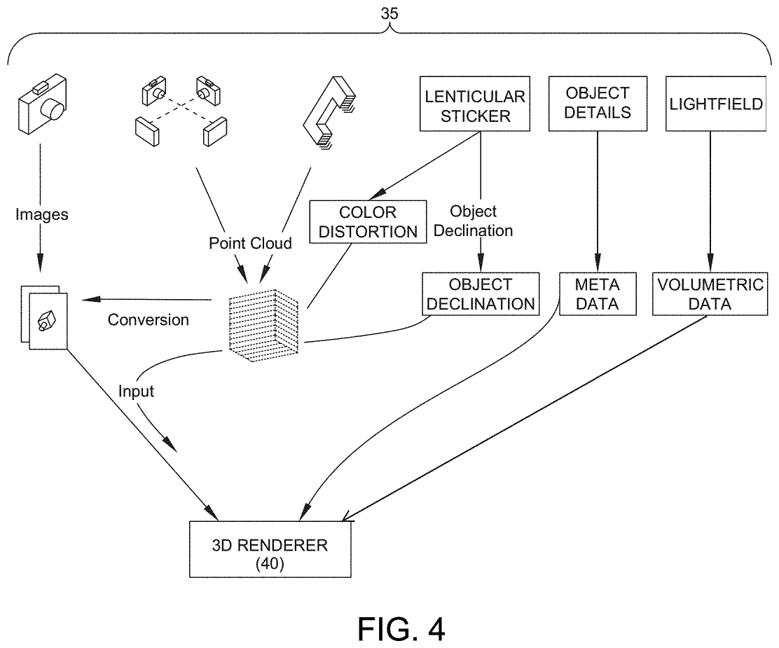

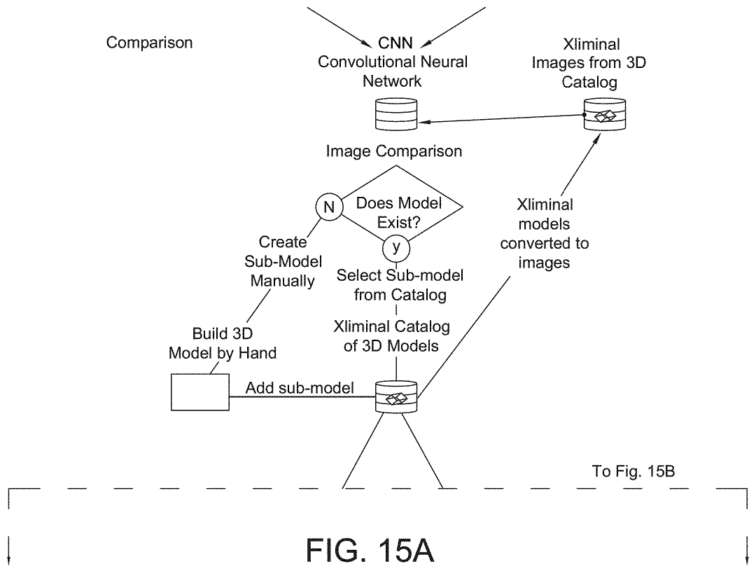

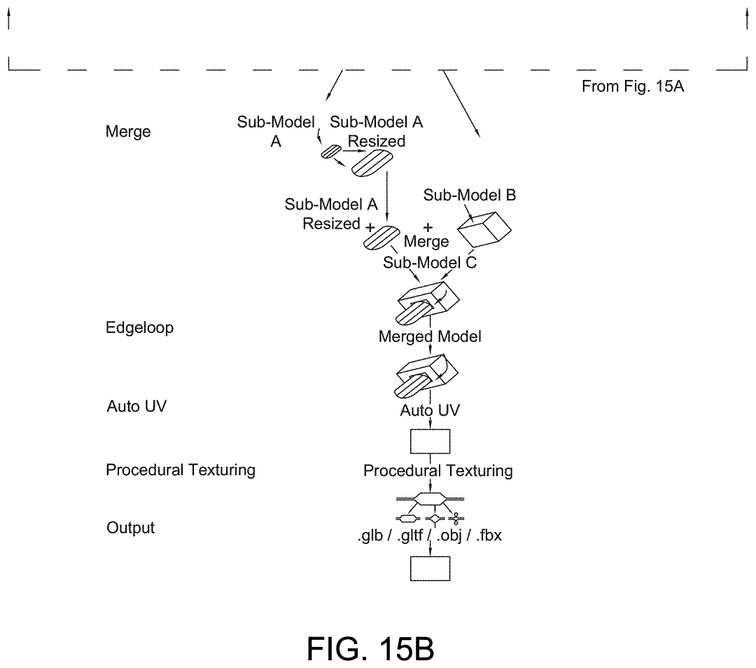

FIG. 4 shows a flow diagram of image data 35 received by the renderer 40 from the source 30 (shown in FIG. 1), wherein the image data 35 includes static image data or point cloud data for rendering a 3D object. The image data 35 can include object rendering data, or the object rendering data can be provided separately. The object rendering data can include object declination data, object color distortion data, object feed data, or light field data. The object feed data can include metadata, including object details. The light field data can include volumetric data corresponding to the object. The image data 35 can originate from, for example, a digital camera, an image pickup device (for example, stereo image pickup unit 4, shown in FIG. 2B), a 3D scanner, a 3D camera, a 3D CAD generator, or other source of image content. Image data originating from sources, such as, for example, 3D scanners, 3D camera systems, or 3D CAD generators can be received as point clouds. The point clouds can be converted to 2D static images before being input to the renderer 40. The image data 35 can include object rendering data that is created with implementation of a practice device 50. FIGS. 15A and 15B show an example a process that can be carried out by the renderer 40 based on the image data 35.

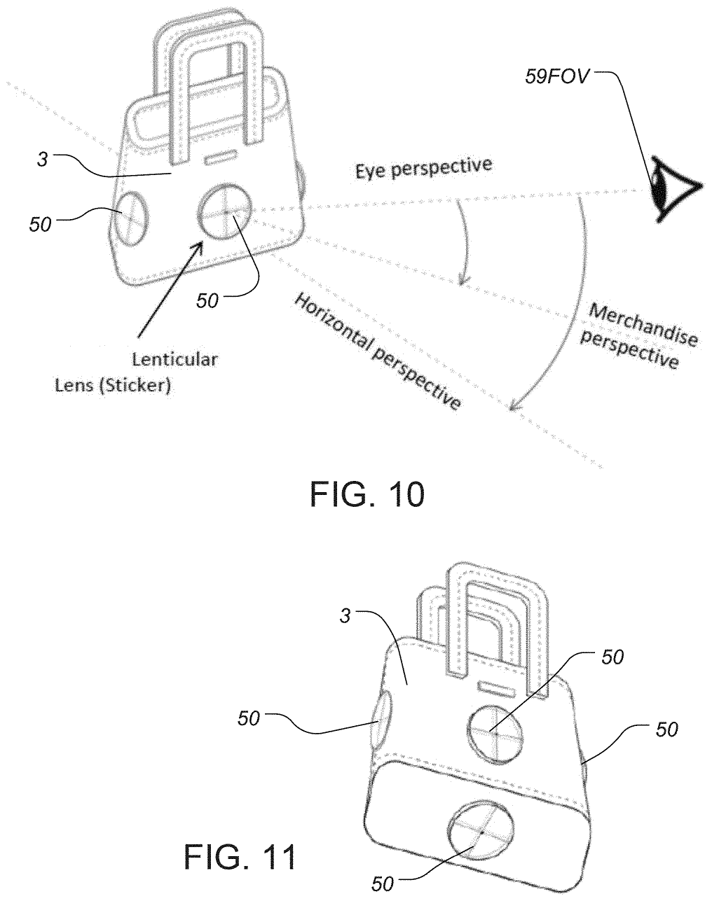

FIG. 5 shows a nonlimiting embodiment of the protractic device 50, constructed according to the principles of the disclosure. The protractic device 50 can be applied to an object that can be rendered as the interactable 3D object 3 (shown in FIG. 2A). The protractic device 50 can be applied to, for example, one or more surfaces of the original object and imaged by an image pickup device 59 (shown in FIG. 6) in its field of view 59FOV (shown in FIG. 9) from one or more vantage points to build object rendering data for the object 3 (for example, shown in FIGS. 10 and 11). The protractic device 50 can be applied to the object to build object declination data, object color distortion data, or light field data for the object 3. The object rendering data can be included with one or more images of the object to form, for example, the image data 35 (shown in FIG. 4).

In a nonlimiting embodiment, the protractic device 50 can include a plurality of panels that are juxtapositioned to facilitate angle detection and determination and/or color distortion detection and determination using the image pickup device 59 (shown in FIG. 6), which can include, for example, a digital camera, a digital stereo camera, a mobile phone camera, or any device capable of capturing a digital image of the object to build object rendering data, including object declination data and object color distortion data. The protractic device 50 can be formed as a lenticular sheet, a lenticular sticker, or a plurality of parallel panels that are offset from each other along an axis, such as, for example, along an x-axis, y-axis, or z-axis in the Cartesian coordinate system. Each panel can include a lenticular lens, a lenticular sheet, a lenticular sticker or a planar surface. As seen in the nonlimiting example shown in FIG. 5, the protractic device 50 can include a pair of planar panels 51, 52 that are juxtapositioned.

In a nonlimiting embodiment, the protractic device 50 can be made from a front (or back) panel 51 and a back (or front) panel 52, which can be assembled into a single unit such that the panels 51 and 52 are positioned as seen in FIG. 5. The panels 51, 52 can be formed as on or more lenses. The panels 51, 52 can be substantially parallel with respect to each other, but offset by a distance along an axis, such as, for example, along the x-axis, y-axis, or z-axis in the Cartesian coordinate system. The protractic device 50 can be formed as a lenticular lens or sticker having a pair of juxtaposed lenticular sheets. The protractic device 50 can have any shape, including, for example, a square, a rectangle, a circle, a semi-circle, an ellipse, a pyramid, a star, a random shape, or any other shape that might be desirable or suitable for an object. The protractic device 50 can have a three-dimensional shape such as, for example, a sphere, a semi-sphere, a cube, a cylinder (for example, a 3D disc), a pyramid, or any other 3D shape that might desirable or suitable for use with a particular object.

In addition to capturing relative declination or scale, the protractic device 50 can measure any color distortion caused by light dispersion or other environmental factors specific to the place or time the static images are being captured. The protractic device 50 can do this by comparing the distortion to hue, saturation or luminance at the time the images are taken with these markers, such as, for example, with standard lighting that might exist at the time of image capture.

FIG. 6 shows an exploded view of the nonlimiting embodiment of the protractic device 50, including the front panel 51 and the back panel 52. As seen in FIG. 6, protractic device 50 can be used with the image pickup device (IPD) 59 to build object rendering data. The panels 51 and 52 can be aligned along a common axis, but offset from each other by a predetermined distance. The common axis can be a central axis that is common to both panels 51, 52. Alternatively, the panels 51 and 52 can be aligned along their respective perimeters, such that the panels 51, 52 substantially overlap and their edges align.

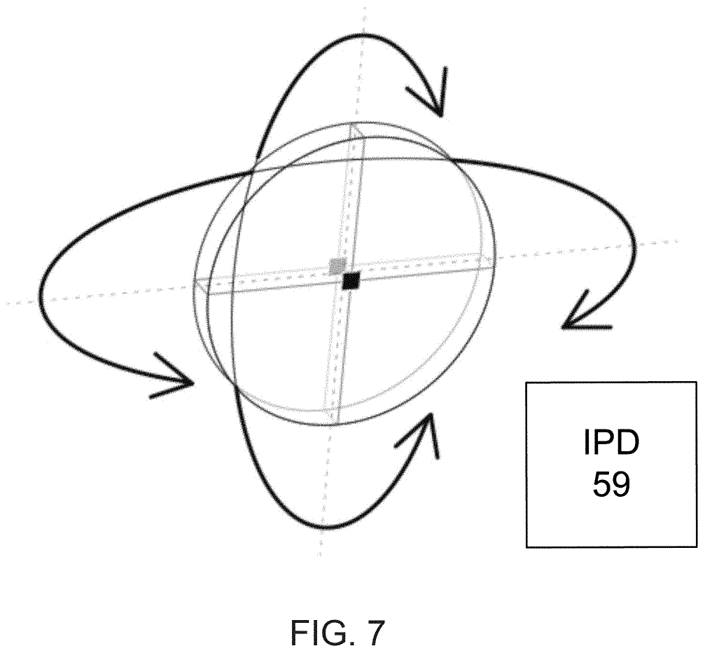

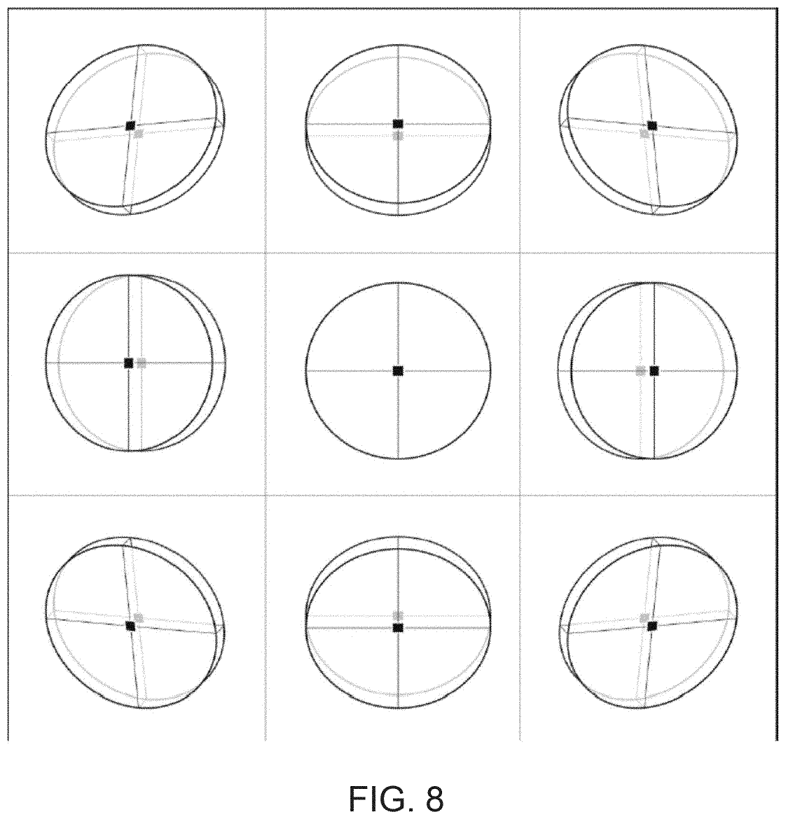

FIG. 7 depicts an example of multiple rotational axes of visibility that can be attained via the protractic device 50. By maneuvering the protractic device 50 in the 3D real-world coordinate system, such as, for example, by pivoting, rotating or otherwise moving the protractive device 50, multiple views of an object can be captured by the IPD 59.

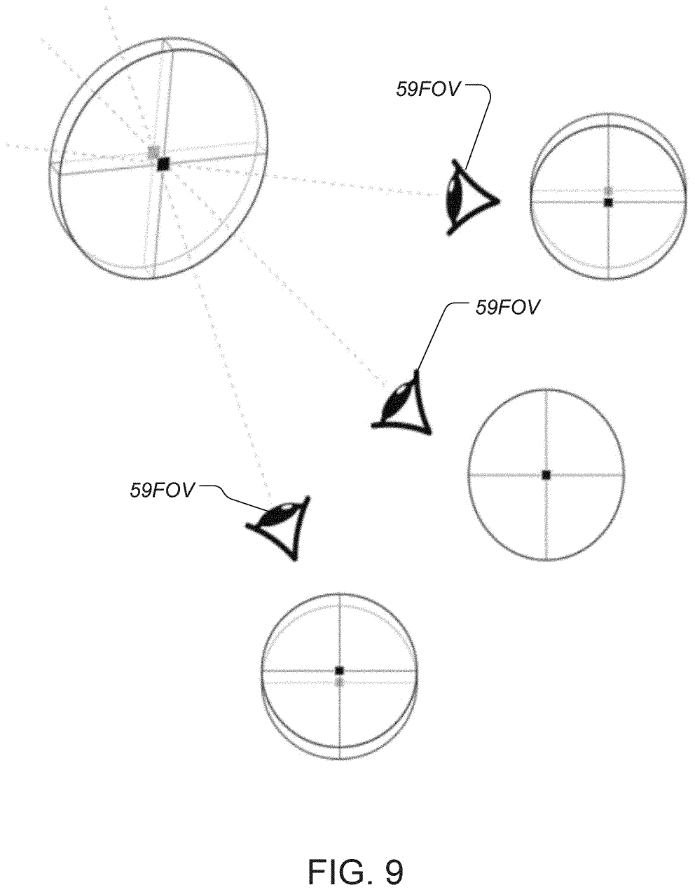

FIG. 8 shows various examples of relations between panels 51 and 52 of the protractic device 50, showing the relation of the front panel 51 to the back panel 52 at different angles with respect to which the IPD 59 (shown in FIG. 7) can be positioned.

FIG. 9 shows an example of a relation of the front panel 51 and back panel 52 in the protractic device 50 at three different viewing angles. The field of view 59FOV of the IPD 59 (shown in FIG. 7) can be positioned at each of the viewing angles. The front panel 51 can be located in a first plane and the back panel 52 can be located in a second plane, such that the first and second planes are parallel to each other, but offset from each other by a predetermined distance, which can range from a few millimeters to a centimeter or more. The front and back panels 51, 52 can be the same size or different sizes. As seen in FIG. 9, a relative declination can be determined between the front and back panels 51, 52 relative to the eye. The determined declination can include the angle between the optical axis of image pickup device 59 and the common axis of the front and back panels 51, 52. The common axis can be perpendicular to the planes of the front and back panels 51, 52, and co-located at the centers of the panels 51, 52.

FIG. 10 shows an example of a view of the object 3, which in this example includes a perspective top-left-front view of the object 3 with multiple protractic devices 50 attached to surfaces of the object 3. According to a nonlimiting embodiment, five protractic devices 50 can be attached to the surfaces of the object 3, including a protractic device 50 at each of the bottom surface, right-side surface, left-side surface, front surface, and back surface of the object 3. The top surface of the object 3 can also be provided with a protractic device 50. Each of the protractic devices 50 can be referenced to determine declination and/or color distortion data for each of the surfaces of the object 3. For instance, six still images of the object 3 can be captured, including, for example, top, bottom, right, left, front, and back views; and, associated declination data can be determined for each surface of the object 3. The declination data or color distortion data can include field of view 59FOV (or eye) perspective data of the IPD 59 and horizontal perspective data.

FIG. 11 shows another view of the object 3 with multiple protractic devices 50, which in this example is a bottom-left-front perspective view of the object 3. The images of the object captured by the IPD 59 and determined object rendering data, including, for example, declination data and color distortion data, can be transmitted to the renderer 40 (shown in FIGS. 1 and 3) over a communication link. The IPD 59 can be included in the image source 30 (shown in FIG. 1).

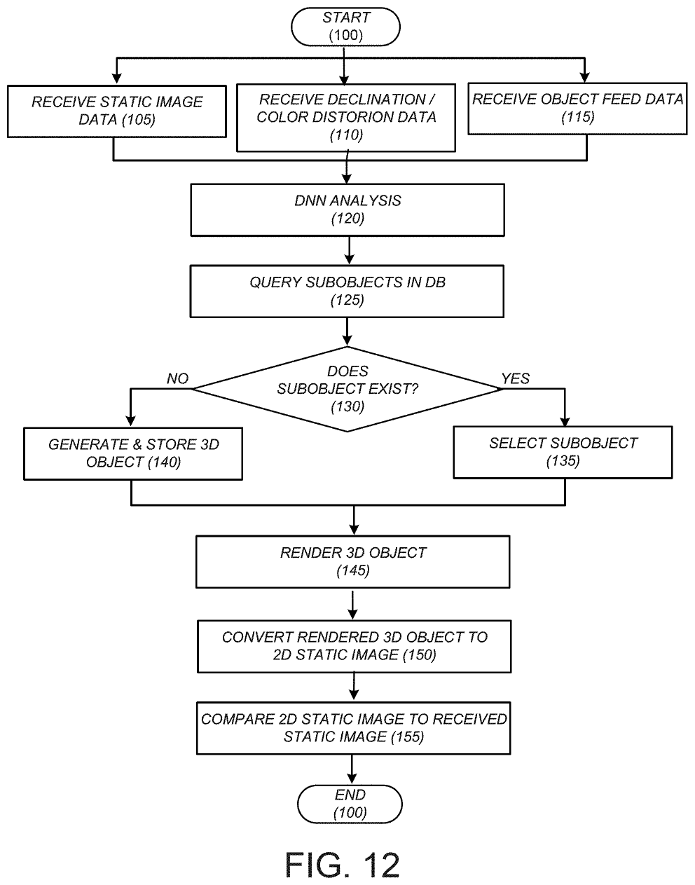

FIG. 12 shows a nonlimiting embodiment of a 3D rendering process 100 that can be performed by, for example, the renderer 40 (shown in FIGS. 1 and 3). Referring to FIG. 1, the renderer 40 can process an image of an object to be rendered as an interactable 3D object on the communicating device 10, including processing declination data, color distortion data and/or luminosity data received from the image source 30 for the object. The image source 30 can include the IPD 59 (for example, shown FIG. 7) and one or more protractic devices 50 to generate static 2D image data for the object 3 and determine object rendering data for the object that can be used by the renderer 40 to generate the interactable 3D object 3 (shown in FIG. 2A). The renderer 40 can be arranged to compare the rendered interactable 3D object to the original static 2D image data for the object 3 to determine matchability. In this regard, machine-based pixel comparisons can be carried out by the renderer 40 (for example, the image analyzer 42, shown in FIG. 3) between the original static image data and 3D-to-2D converted static image data to identify discrepancies in pixel signatures. The comparison data can be used to train the image analyzer 42 (shown in FIG. 3).

The renderer 40 can be arranged to receive the image data (Step 105) and object rendering data, including, for example, declination data, color distortion data and/or luminosity data (Step 110) from the image source 30 (shown in FIG. 1). As noted above, the image source 30 can include one or more protractic devices 50 and/or one or more IPDs 59 (for example, one IPD 59 shown in FIG. 7), which can be arranged to determine and provide the declination data, color distortion data and/or luminosity data. The image data can include a static image of an object that is to be rendered into 3D. The received image data can include image data 35 (shown in FIG. 4), which can include 2D or 3D image data. Object rendering data, including declination data, color distortion data and/or luminosity data, associated with the image data 35 can also be received by the renderer 40 (Step 110). The object rendering data can be included in the image data 35. The object rendering data can be received from the image source 30 (shown in FIG. 1), which can include, for example, one or more IPDs 59 (shown in FIG. 6) that determined declination data for the object 3 using one or more protractic devices 50 (shown in FIG. 6).

The renderer 40 can receive object feed data (Step 115). The object feed data can be included in the image data 35 (shown in FIG. 4). The object feed data can include detailed information about the object 3. The object feed data can include a product data feed for the object where the object is a product. The product data feed can be received from the image source 30 (shown in FIG. 1). The image source 30 can include, for example, a webserver (not shown) or database (not shown) connected to the Internet.

The renderer 40 can receive image data 35 (Step 105), object rendering data (Step 110) or object feed data (115) and analyze the image content, for example, by the image analyzer 42 (shown in FIG. 3) using a deep convolutional neural network (Step 120). In analyzing the image content, the renderer 40 can detect and identify subobjects (for example, polygons or groups of polygons) in the image content. The identified subobjects can be used to query a library (or catalog) of subobjects (for example, stored in the database 49, shown in FIG. 3) and determine whether any renderable subobjects exist (Step 130). If it is determined that a renderable subobject exists (YES at Step 130), then that subobject can be selected and retrieved for inclusion in 3D modeling (for example, at the model builder 44, shown in FIG. 3) (Step 135), otherwise (NO at Step 130) a renderable subobject can be generated and stored in the library. The renderable subobject can be generated automatically or through interaction with a human operator. As noted previously, the renderer 40 can include a plurality of libraries, each of which can include subobjects and associated metadata for each category, class or type of object.

Once all subobjects have been selected (Step 135) or generated (Step 140), the object (for example, object 3 shown in FIG. 2A) can be rendered in 3D (Step 145). The 3D object can be rendered as the subobjects are being selected or generated. In rendering the object in 3D, the selected subobjects can be adjusted in size, position, color, luminosity, texture, or material properties, and merged to form the 3D object (for example, object 3 shown in FIG. 2A). Additionally, in rendering the interactable 3D object, environmental variables can be used to render each of the subobjects dynamically so that the subobjects can morph based on the environment within which each subobject is placed, including direction of motion, speed of motion, and impact of environmental variables on each subobject as a function of time, such as, for example, perspective, motion, temperature, wind direction, or other environmental factor. Steps 120 to 145 can be repeated until 3D rendering of the object 3 (shown in FIG. 2A) is complete. Each subobject can include a polygon.

The rendered interactable 3D object can be converted by the renderer 40 to 2D static images (Step 150) for quality control and/or tuning modeling parameters or training the machine intelligence in the renderer 40. The resultant 2D static images can be compared against image content in the original image data 35 (for example, static 2D images) received at Step 105 (Step 155). The comparison data can be used by the renderer 40 to, for example, train the deep convolutional neural network in the image analyzer 42 (shown in FIG. 3). The comparison data can be used by the renderer 40 to modify or re-render the object into 3D. The comparison data can be used as a quality assurance check on the process 100.

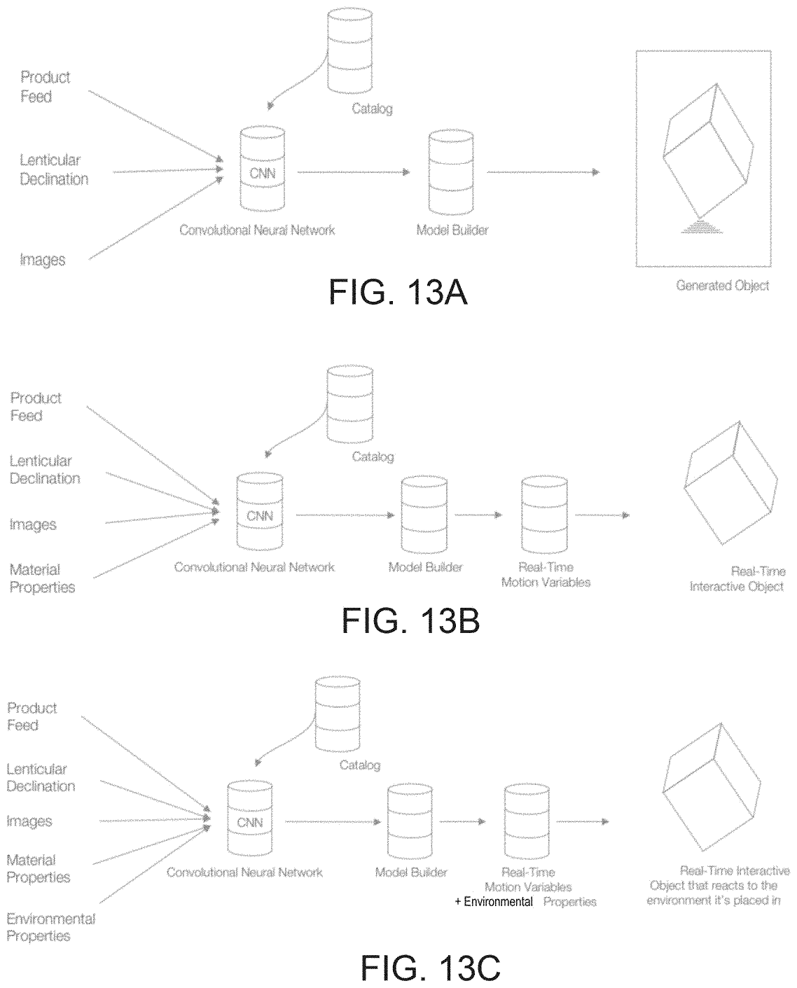

FIGS. 13A to 13C show nonlimiting examples of three phases that can be carried out by the renderer 40 (shown in FIG. 3) to render the interactable object (for example, object 3 shown in FIG. 2A) as a product in 3D that can interact with real-world image content captured by, for example, the image pickup unit 4 (shown in FIG. 2B). The first phase can include receiving, by the convolutional neural network (CNN) in the renderer 40 the image data 35 (shown in FIG. 4), which in this example can include static images of the product, declination data (or lenticular declination data), and product feed data from image source 30 (shown in FIG. 1), and receiving catalog data from the 3D cataloger 46 (shown in FIG. 3). The first phase can include building a model, by the model builder 44 (shown in FIG. 3), based on image analysis results to render a 3D image of the product as a collection of subobjects (for example, static polygons).

The second phase can include applying, for example, by the RT motion processor 47 (shown in FIG. 4), real-time motion variables to the model to render 3D images of the product as a collection of subjobects that morph based on direction or velocity or changes indirection or velocity. The second phase can include, in addition to those in the first phase, rendering dynamic polygons (subobjects) that predict how polygons will morph based on direction or velocity or changes in direction or velocity with respect to time for the movement.

The third phase can include applying environmental variables to the model, in addition to real-time motion variables. This phase include applying environmental variables that can render context sensitive polygons (subobjects) into dynamic polygons (subobjects) that are context sensitive and accurate. The dynamic polygons can adjust for various environmental variables as they morph, including, for example, declination (or perspective), motion, temperature, wind direction, or other environmental factors.

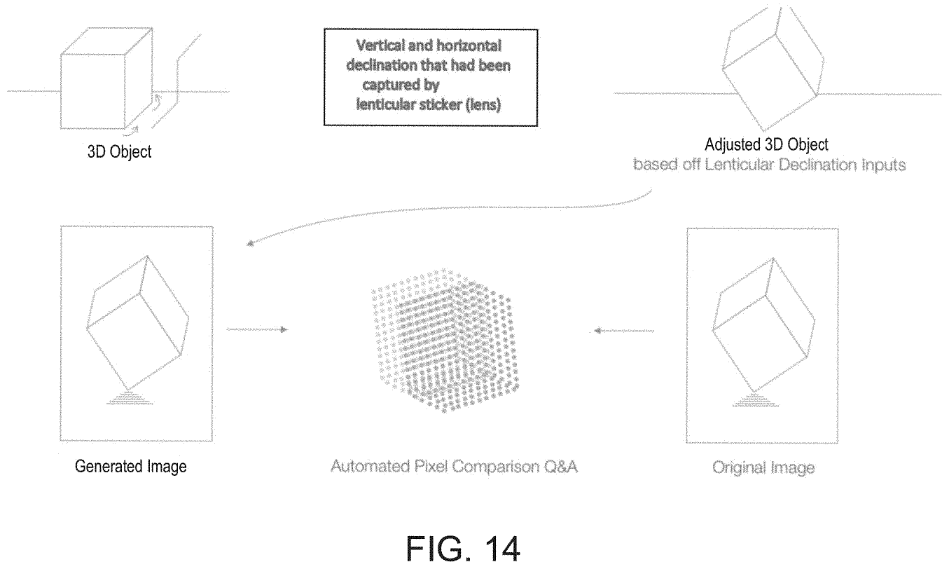

FIG. 14 depicts a flow diagram that illustrates a nonlimiting example of quality assurance process that can be carried out by the renderer 40 (shown in FIG. 3). The renderer 40 can use the rendered interactable 3D object (Generated Image) along with the declination data (for example, captured using the protractic device 50, shown in FIG. 5) to generate a static image (3D Object) that can be matched against the original image content input to the renderer 40 (Original Image). The model builder 44 (shown in FIG. 3), for example, using machine-based pixel comparisons, can identify discrepancies in pixel signatures between the images and apply the results of the comparison to adjust or update modeling parameters in the machine-learning platform in the renderer 40, such as, for example, in the image analyzer 42 or model builder 44.

FIGS. 15A and 15B depict an example of a flow diagram of a nonlimiting embodiment of the renderer 40 (shown in FIG. 3) based on the image data 35 (shown in FIG. 4). After the renderer 40 receives the image data 35, including static image data, point cloud data, object declination data, color distortion data, object detail data, or lightfield data, the CNN in the renderer 40 can analyze the image data 35 along with associated 3D image data from the cataloger (for example, cataloger 46, shown in FIG. 3) to detect, classify and track image content in the image data, including the object that is to be rendered as an interactable 3D object (for example, object 3 shown in FIG. 2A). The analyzed image content can be compared, for example, by the model builder 44 (shown in FIG. 4), against one or more models to determine whether a model exists for the particular image content or object, or any portion thereof. If it is determined that a model does not exist (N), then subobjects can be created for the image content or object, for example, manually, and used to build a 3D model for the image content or object, which can then be added to a catalog library, including all the subobjects that are created in the process. Each subobject can include a submodel or a polygon.

If a model is found to exist for the image content or object (Y), then subobjects are selected by the cataloger 46 (shown in FIG. 4) and used, for example, by the model builder 44 (shown in FIG. 4) to build the model for the image content or object, resizing subobjects (for example, Sub-Model A) and merging the subobjects (Sub-Model A) with other subobjects (for example, Sub-Model B) to form an aggregate subobject (for example, Sub-Model C), connecting edges across surfaces using, for example, Edge loop, and UV mapping the image texture data onto a 3D mesh, as will be understood by those skilled in 3D image processing. The process can include procedural texturing and outputting a rendered 3D object as, for example, .glb, .gltf, .obj, or .fbx format file.

The terms “a,” “an,” and “the,” as used in this disclosure, means “one or more,” unless expressly specified otherwise.

The term “backbone,” as used in this disclosure, means a transmission medium or infrastructure that interconnects one or more computing devices or communication devices to provide a path that conveys data packets and instruction signals between the one or more computing devices or communication devices. The backbone can include a network. The backbone can include an ethernet TCP/IP. The backbone can include a distributed backbone, a collapsed backbone, a parallel backbone or a serial backbone.

The term “bus,” as used in this disclosure, means any of several types of bus structures that can further interconnect to a memory bus (with or without a memory controller), a peripheral bus, or a local bus using any of a variety of commercially available bus architectures. The term “bus” can include a backbone.

The term “communicating device,” as used in this disclosure, means any computing device, hardware, firmware, or computing resource that can transmit or receive data packets, instruction signals or data signals over a communication link. The communicating device can include, for example, a telephone, a smart phone, a personal data assistant (PDA), a smart watch, a tablet, a computer, a software defined radio (SDR), a digital camera, an image pickup device, a scanner, or an Internet of Things (IoT) device, without limitation. The communicating device can be portable or stationary.

The term “communication link,” as used in this disclosure, means a wired and/or wireless medium that conveys data or information between at least two points. The wired or wireless medium can include, for example, a metallic conductor link, a radio frequency (RF) communication link, an Infrared (IR) communication link, or an optical communication link. The RF communication link can include, for example, WiFi, WiMAX, IEEE 802.11, DECT, 0G, 1G, 2G, 3G, 4G or 5G cellular standards, Bluetooth, or the like, without limitation. A communication link can include, for example, an RS-232, RS-422, RS-485, or any other suitable interface.

The terms “computer,” “computing device,” or “processor,” as used in this disclosure, means any machine, device, circuit, component, or module, or any system of machines, devices, circuits, components, or modules that are capable of manipulating data according to one or more instructions. The terms “computer,” “computing device” or “processor” can include, for example, without limitation, a processor, a microprocessor (μC), a central processing unit, a graphic processing unit (GPU), a general-purpose GPU (GPGPU), a field programmable gate array (FGPA), an application specific integrated circuit (ASIC), a general purpose computer (CPU), a super computer, a personal computer, a laptop computer, a palmtop computer, a notebook computer, a desktop computer, a workstation computer, a server, a server farm, a computer cloud, or an array of processors, μCs, CPUs, GPUs, GPGPUs, FGPAs, ASICs, general purpose computers, super computers, personal computers, laptop computers, palmtop computers, notebook computers, desktop computers, workstation computers, or servers, without limitation.

The term “computer-readable medium,” as used in this disclosure, means any non-transitory storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium can include a “Cloud,” which includes a distribution of files across multiple (e.g., thousands of) memory caches on multiple (e.g., thousands of) computers.

Various forms of computer readable media can be involved in carrying sequences of instructions to a computer. For example, sequences of instruction (i) can be delivered from a RAM to a processor, (ii) can be carried over a wireless transmission medium, and/or (iii) can be formatted according to numerous formats, standards or protocols, including, for example, WiFi, WiMAX, IEEE 802.11, DECT, 0G, 1G, 2G, 3G, 4G, or 5G cellular standards, or Bluetooth.

The term “computing resource,” as used in this disclosure, means software, a software application, a web application, a web page, a computer application, a computer program, computer code, machine executable instructions, firmware, or a process that can be arranged to execute on a computing device or a communicating device.

The term “database,” as used in this disclosure, means any combination of software and/or hardware, including at least one application and/or at least one computer. The database can include a structured collection of records or data organized according to a database model, such as, for example, but not limited to at least one of a relational model, a hierarchical model, or a network model. The database can include a database management system application (DBMS) as is known in the art. The at least one application may include, but is not limited to, for example, an application program that can accept connections to service requests from clients by sending back responses to the clients. The database can be configured to run the at least one application, often under heavy workloads, unattended, for extended periods of time with minimal human direction.

The terms “including,” “comprising” and variations thereof, as used in this disclosure, mean “including, but not limited to,” unless expressly specified otherwise.

The term “network,” as used in this disclosure means, but is not limited to, for example, at least one of a a personal area network (PAN), a local area network (LAN), a wireless local area network (WLAN), a campus area network (CAN), a metropolitan area network (MAN), a wide area network (WAN), a metropolitan area network (MAN), a wide area network (WAN), a global area network (GAN), a broadband area network (BAN), a cellular network, a storage-area network (SAN), a system-area network, a passive optical local area network (POLAN), an enterprise private network (EPN), a virtual private network (VPN), the Internet, or the like, or any combination of the foregoing, any of which can be configured to communicate data via a wireless and/or a wired communication medium. These networks can run a variety of protocols, including, but not limited to, for example, Ethernet, IP, IPX, TCP, UDP, SPX, IP, IRC, HTTP, FTP, Telnet, SMTP, DNS, ARP, ICMP.

The term “server,” as used in this disclosure, means any combination of software and/or hardware, including at least one application and/or at least one computer to perform services for connected clients as part of a client-server architecture. The at least one server application can include, but is not limited to, for example, an application program that can accept connections to service requests from clients by sending back responses to the clients. The server can be configured to run the at least one application, often under heavy workloads, unattended, for extended periods of time with minimal human direction. The server can include a plurality of computers configured, with the at least one application being divided among the computers depending upon the workload. For example, under light loading, the at least one application can run on a single computer. However, under heavy loading, multiple computers can be required to run the at least one application. The server, or any if its computers, can also be used as a workstation. The server can include a server farmer or a computer cloud.

The term “transmission,” as used in this disclosure, means the conveyance of signals via electricity, acoustic waves, light waves and other electromagnetic emissions, such as those generated with communications in the radio frequency (RF) or infrared (IR) spectra. Transmission media for such transmissions can include coaxial cables, copper wire and fiber optics, including the wires that comprise a system bus coupled to the processor.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential or a parallel order, such processes, methods and algorithms may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes, methods or algorithms described herein may be performed in any order practical.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A method for rendering an object in three-dimensions and displaying the object in an augmented reality environment, the method comprising:
receiving static image data;
receiving object rendering data corresponding to the static image data;
analyzing the static image data to identify a subobject;
querying a catalog based on the identified subobject and retrieving a rendered subobject;
rendering an interactable 3D image of the object using the retrieved rendered subobject; and
transmitting the interactable 3D object to a display device,
wherein the object rendering data comprises at least one of declination data and color distortion data.

2. The method of claim 1, further comprising:
receiving object feed data; and
analyzing the object feed data with the static image and object rendering data to identify the subobject.

3. The method of claim 1, wherein the object rendering data is determined using a protractic device.

4. The method of claim 1, wherein the object rendering data is determined using a protractic device and an image pickup device.

5. The method of claim 1, further comprising:
converting the interactable 3D image of the object to a two-dimensional (2D) static image; and
comparing the 2D still image against the received static image data.

6. The method of claim 5, wherein the converting the interactable 3D image to the 2D static image comprises generating associated object rendering data.

7. The method of claim 6, wherein the associated object rendering data comprises at least one of associated declination data, associated color distortion data or associated luminosity data.

8. A non-transitory computer readable storage medium storing executable computer program instructions that, when executed on a computing device, cause the computing device to perform a method comprising:
receiving static image data;
receiving object rendering data corresponding to the static image data;
analyzing the static image data to identify a subobject;
querying a catalog based on the identified subobject and retrieving a rendered subobject;
rendering an interactable 3D image of the object using the retrieved rendered subobject; and
transmitting the interactable 3D object to a display device,
wherein the object rendering data comprises at least one of declination data and color distortion data.

9. The non-transitory computer readable storage medium in claim 8, wherein the method further comprises:
receiving object feed data; and
analyzing the object feed data with the static image and object rendering data to identify the subobject.

10. The non-transitory computer readable storage medium in claim 8, wherein the object rendering data is determined using a protractic device.

11. The non-transitory computer readable storage medium in claim 8, wherein the object rendering data is determined using a protractic device and an image pickup device.

12. The non-transitory computer readable storage medium in claim 8, wherein the method further comprises:
converting the interactable 3D image of the object to a two-dimensional (2D) static image; and
comparing the 2D still image against the received static image data.

13. The non-transitory computer readable storage medium in claim 12, wherein the converting the interactable 3D image to the 2D static image comprises generating associated object rendering data.

14. The non-transitory computer readable storage medium in claim 13, wherein the associated object rendering data comprises at least one of associated declination data, associated color distortion data or associated luminosity data.

15. A system for rendering an object in three-dimensions and displaying the object in an augmented reality environment, the system comprising
a three-dimensional renderer arranged to
analyze image content and object rendering data corresponding to an image of an object in the image content,
identify a subobject based on the image content,
retrieve a rendered subobject based on the identified subobject,
merge the rendered subobject with another subobject to render an interactable 3D image of the object, and
transmit the interactable 3D image of the object to a communicating device,
wherein the object rendering data comprises at least one of declination data and color distortion data.

16. The system in claim 15, further comprising:
a protractic device arranged to attach to a surface of the object; and
an image pickup device having a field of view and arranged to capture an image of the protractic device in the field of view to determine an object declination or color distortion,
wherein the declination data and color distortion data comprise the object declination and color distortion, respectively.

17. The system in claim 16, wherein the protractic device comprises:
a first panel; and
a second panel.

18. The system in claim 17, wherein the first and second panels are parallel and juxtapositioned.

19. The system in claim 17, wherein the first and second panels comprise first and second planar panels, respectively.

20. The system in claim 16, wherein the protractic device comprises a pair of lenticular lenses.
